(19) United States
(12) Patent Application Publication
(10) Pub. No.: US 2019/0067969 A1
(43) Pub. Date: Feb. 28, 2019

(54) DEVICE FOR CHARGING AN ELECTRIC ENERGY STORE, AND METHOD FOR INITIALIZING A CHARGING PROCESS FOR AN ELECTRIC ENERGY STORE

(71) Applicant: Robert Bosch GmbH, Stuttgart (DE)

(72) Inventors: Oliver Blum, Renningen (DE); Philipp Schumann, Stuttgart (DE)

(21) Appl. No.: 16/080,048

(22) PCT Filed: Feb. 9, 2017
(86) PCT No.: PCT/EP2017/052846

§ 371 Date: Aug. 27, 2018

(30) Foreign Application Priority Data
Feb. 29, 2016 (DE) 10 2016 203 172.4

(51) Int. Cl. H02J 7/00; H02J 7/34; H02J 50/10

(52) U.S. Cl. CPC H02J 7/0052; H02J 7/0072; H02J 7/0031; H02J 50/10; H02J 2007/0059; H02J 7/345

(57) ABSTRACT

The invention relates to an efficient way to charge DC link capacitor in a charging circuit for an electric energy store. To this end, the DC link capacitor of the charging circuit is initially charged, by means of the charging circuit, to a voltage in the range of a voltage across the terminals of the electric energy store to be charged. The DC link capacitor is electrically connected to the electric energy store to be charged only once the DC link capacitor has been charged to the predefined voltage.

### BACKGROUND OF THE INVENTION

The present invention relates to a device for charging an electric energy store and a method for initializing a charging process for an electric energy store.

The document DE 10 2014 207 854 A1 discloses a transmission system for the contactless transfer of energy to a consumer. For example, such an energy transfer can be used to charge batteries of electric vehicles or hybrid vehicles.

In the inductive charging of energy stores, for example in the case of the inductive charging of traction batteries for electric vehicles, the electric energy is transferred via a transformer with a large air gap. For energy transfer a primary coil generates a high-frequency alternating magnetic field, which penetrates a secondary coil and induces a corresponding current there. As the frequency range for the energy transfer, a frequency between 10 and 150 kHz is typically used.

On the secondary side, a so-called DC link capacitor is used for voltage stabilization. In the charging mode, this capacitor is charged up to the voltage of the battery to be charged. Before the start of the charging operation the charging system including the DC link capacitor is disconnected from the battery by means of a line protection switch or circuit breaker or contactor. For safety reasons, a discharge of the DC link capacitor is also provided.

To prevent high discharge currents between the battery and the capacitor when closing the circuit breaker, the DC link capacitor must be charged up to the battery voltage in advance. For this purpose, so-called pre-charging circuits, for example, can be provided.

### SUMMARY OF THE INVENTION

The present invention discloses a device for charging an electrical energy store, and a method for initializing a charging process for an electric energy store.

Accordingly, the following are provided:

A device for charging an electric energy store with a charging circuit, a DC link capacitor, a circuit breaker, a first voltage detector, a second voltage detector and a control device. The charging circuit can be electrically coupled with an electric energy source at an input terminal. The charging circuit is also designed to provide a DC voltage or a DC current at an output terminal. The DC link capacitor is electrically connected to the output terminal of the charging circuit. The circuit breaker is arranged in an electrical path between the DC link capacitor and the electric energy store. The circuit breaker is designed to open or close an electrical connection between the DC link capacitor and the electric energy store. The first voltage detector is designed to detect an open-circuit voltage of the electric energy store. The first voltage detector can provide an output signal corresponding to the detected open-circuit voltage. The second voltage detector is designed to detect a DC link voltage between the two terminals of the DC link capacitor. In doing so, the second voltage detector can provide an output signal that corresponds to the first detected DC link voltage. The control device is designed to calculate an enable voltage using the detected open-circuit voltage. Furthermore, the control device can provide a control signal at the charging circuit to charge up the DC link capacitor. In addition, the control device can control the circuit breaker if the DC link voltage matches the calculated enable voltage. In particular, the circuit breaker is closed by activating the circuit breaker.

Also provided are:

A method for initializing a charging process of an electric energy store having the steps of detecting an open-circuit voltage of the electric energy store; the calculation of an enable voltage using the detected open-circuit voltage of the electric energy store; the charging of a DC link capacitor which is coupled with the electric energy store via an open circuit breaker, by means of a charging circuit for the electric energy store; and the closure of the circuit breaker if the value of the electrical voltage across the DC link capacitor corresponds to the calculated enable voltage.

The present invention is based on the recognition that when a charging circuit is electrically connected to a battery, high compensating currents can occur as a result of capacitive components in the charging circuit. Therefore, these capacitive components must be charged to a suitable voltage level before making the connection. The present invention is also based on the recognition that such a charging of the capacitive components by means of a separate charging circuit can be associated with a high circuit complexity, and, in a vehicle architecture, connection means to the battery certainly exist, which by default do not contain a separate pre-charging circuit.

Therefore, an idea of the present invention is to exploit this fact and to provide a method and a circuit arrangement, which allow the charging circuit to be charged up to a suitable voltage level as simply as possible and with low complexity before being electrically connected to the battery.

The present invention therefore provides for charging up a DC link capacitor in a device for charging an electric energy store to a suitable voltage level firstly by means of a charging circuit provided in the charging device, before electrically connecting the charging device to the electric energy store. This suitable voltage level can be in the range of the open-circuit voltage of the energy store to be charged. This however, does not require the DC link capacitor to be charged exactly to the open-circuit voltage of the electric energy store. Even in the case of minor voltage differences between the DC link capacitor and the open-circuit voltage, an electrical connection is possible by closing a circuit breaker without the circuit breaker or other components suffering damage.

Since the charging of the DC link capacitor takes place via the charging circuit, the charging can be performed with already existing components and modules without substantial additional circuitry being required. This allows both the necessary installation space and the manufacturing costs to be reduced.

The capacitances in the charging device are charged by the charging device itself, so that before the circuit breaker is closed there is also no need to set up an electrical connection between the energy store and the charging device. Therefore, the isolation between the energy store and the charging device, or any connections or charging sockets that may be present, can be guaranteed before the beginning of the charging process.

According to one embodiment, the control device is designed to enable a charging process for charging the electric energy store by means of the charging circuit, after the circuit breaker has been closed. In this way, after closing the circuit breaker an energy transfer from the charging circuit to the electric energy store can be performed.

According to a further embodiment, the control device is designed to enable the charging of the electric energy store only if a difference between the detected open-circuit voltage of the electric energy store and the detected DC link voltage falls below a predefined threshold, after the circuit breaker has been closed. By comparing the voltage on the DC link capacitor with the open-circuit voltage of the electric energy store it is possible to check whether the circuit breaker has also been safely closed, or whether a voltage drop occurs across the circuit breaker or, possibly at other points in the connection between DC link capacitor and electric energy store, which could constitute a potential danger during the charging of the energy store.

According to one embodiment, the control device is also designed to provide an enable signal when the charging process for charging the electric energy store is enabled. Such an enable signal can be used, for example, to trigger additional instances or modules for charging the electric energy store.

In accordance with one embodiment, the charging circuit comprises a secondary coil of an inductive energy transmission system. In addition, the charging circuit can also comprise a rectifier circuit. Particularly in the case of inductive energy transmission systems and resonance transformers with a rectifier circuit, by active control of components in the rectifier circuit the charging of the DC link capacitor can be very well controlled.

According to one embodiment, a rectifier circuit of the charging circuit comprises a plurality of semiconductor switches. The control device is designed to actively control the semiconductor switches of the rectifier circuit for charging up the DC link capacitor.

In accordance with one embodiment of the method for initializing the charging process, the step of calculating the enable voltage calculates an enable voltage which differs from the detected open-circuit voltage of the electric energy store by a predetermined value or a predetermined value range. If during the charging process according to the invention a voltage is applied to the DC link capacitor which differs from the open-circuit voltage of the electric energy store, then it is possible to check, for example, whether the circuit breaker between the DC link capacitor and the electric energy store is open or closed. As soon as the circuit breaker is closed, a voltage will then also be obtained on the DC link capacitor of the same level as the open-circuit voltage of the electric energy store, even if a different voltage has previously been set. In this way, the electrical connection between the DC link capacitor and the electric energy store can therefore be checked. For example, a voltage can be applied to the DC link capacitor which differs by a few volts from the open-circuit voltage of the electric energy store. In particular, for example, voltages are possible which differ, for example, by 1-2% of the open-circuit voltage of the electric energy store. On the DC link capacitor both a lower and a higher voltage than the open-circuit voltage of the electrical energy store can be set.

According to a further embodiment, in the step of charging up the DC link capacitor the electrical power provided by the charging circuit is limited to a predefined maximum value. In this way, during the charging of the DC link capacitor with an open circuit breaker the transmitted amount of energy is limited. The safety of the overall system can therefore be increased. After the DC link capacitor has been charged to the desired voltage and the circuit breaker between DC link capacitor and electric energy store has been closed, the charging of the electric energy store can then be enabled with full power.

According to a further embodiment, in order to charge the electric energy store the circuit breaker of the device can comprise a single-phase or a multi-phase circuit breaker. In particular when using multi-phase circuit breakers, a complete galvanic isolation can therefore be enabled between the electric energy store and charging device.

According to one embodiment, the step of charging the DC link capacitor comprises an active control of semiconductor switches in a rectifier circuit of the charging circuit.

Where practical, the above embodiments and extensions can be combined with each other in any way desired. Further embodiments, extensions and implementations of the invention also comprise combinations of features of the invention either described previously or in the following in relation to the exemplary embodiments, which are not explicitly mentioned. In particular, the person skilled in the art will also be able to add individual aspects as improvements or additions to the basic form of the present invention.

### BRIEF DESCRIPTION OF THE DRAWINGS

The present invention will now be described in more detail with the aid of the exemplary embodiments given in the schematic figures of the drawing, in which:

FIG. 1: shows a schematic representation of a device for charging an electric energy store in accordance with one embodiment;

FIG. 2: shows a schematic representation of a block circuit diagram, such as forms the basis of a device for charging an electric energy store; and

FIG. 3: shows a schematic representation of a flow diagram, such as forms the basis of a method in accordance with one embodiment.

### DETAILED DESCRIPTION

In all figures, identical or functionally equivalent elements and devices are labeled with the same reference numeral, unless otherwise indicated.

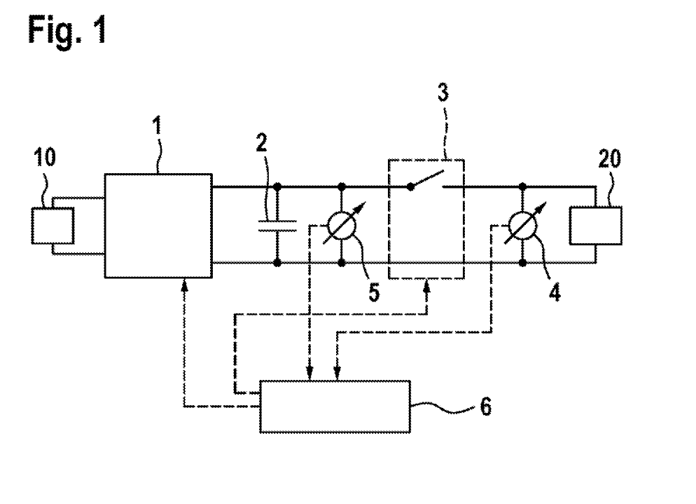

FIG. 1 shows a schematic representation of a device for charging an electric energy store 20. The device comprises a charging circuit 1 with a DC link capacitor 2 and a circuit breaker 3. The charging circuit 1 can be connected to an electric energy source 10 at one input terminal. For example, this electric energy source 10 can be the connection to a power supply network. But any other energy sources, such as for example a photovoltaic system or similar, are also possible. Depending on the configuration of the charging circuit 1, a DC voltage or an AC voltage may be provided at the input terminal of the charging circuit 1 by the electric energy source 10. The charging circuit 1 converts the voltage or current provided at the input terminal into a DC voltage or a DC current to charge the electric energy store 20. In particular, in the charging circuit 1 a galvanic isolation can be effected between input terminal and output terminal of the charging circuit 1. The control of the charging circuit 1 can be performed, for example, by a control device 6.

A DC link capacitor 2 is arranged at the output terminal of the charging circuit 1. The output terminal of the charging circuit 1 with the DC link capacitor 2 provided thereon can be coupled with the electric energy store 20 via a circuit breaker 3. The circuit breaker 3 can be any switching element that is able to reliably switch the voltages and currents that occur. For example, the circuit breaker 3 can be a line safety switch or a contactor. Further switching elements for disconnecting the electrical connection between the electric energy store 20 and charging circuit 1 are also equally possible. In particular, the circuit breaker 3 can be either a single-phase switch, which breaks only one connection between the electric energy store 20 and the charging circuit 1, or alternatively, the circuit breaker 3 can also be a multi-phase switching element which breaks two or more electrical connections between the electric energy store 20 and the charging circuit 1.

As long as no charging of the electric energy store 20 is taking place, the circuit breaker 3 is normally open. For safety reasons, the DC link capacitor 2 is usually discharged. If the circuit breaker 3 were then to be closed, within a very short time a high compensating current would flow from the electrical energy store 20 into the DC link capacitor 2. To prevent this, the DC link capacitor 2 is charged up before the circuit breaker 3 is closed.

To this end, an open-circuit voltage between the two terminals of the electric energy store 20 is first determined. For this purpose, a first voltage detector 4 can be provided on the electric energy store 20. This first voltage detector 4 can be, for example, a voltage detector which is already provided for monitoring the battery voltage. The first voltage detector 4 detects the open-circuit voltage of the electric energy store 20 and then provides an output signal that corresponds to the detected open-circuit voltage. This output signal of the first voltage detector 4 can be provided at the control device 6. This output signal can be, in particular, any analog or digital signal.

The control device 6 can then calculate an enable voltage based on the detected open-circuit voltage on the electric energy store 20, to which the DC link capacitor 2 should be charged before the circuit breaker 3 is closed. In particular, this enable voltage can be in the range of the open-circuit voltage detected on the electric energy store 20. In the case of an enable voltage which matches the detected open-circuit voltage of the electric energy store 20 as closely as possible, a particularly gentle closure of the circuit breaker 3 is possible. On the other hand, in the case of a slight deviation between the voltage on the DC link capacitor 2 and the open-circuit voltage on the electric energy store 20, it can be determined whether the circuit breaker 3 is open or whether the circuit breaker 3 is closed, and thus whether a reliable electrical connection has been established between the charging circuit 1 with the DC link capacitor 2 and the electric energy store 20. Thus, for example, the DC link capacitor 2 can be charged up to a voltage which is slightly above or below the open-circuit voltage of the electric energy store 20. For example, as the enable voltage a voltage can be selected which is several volts, for example 2-5 volts, or for example 1-2% of the open-circuit voltage of the electric energy store 20, below or above the open-circuit voltage of the electric energy store 20. The voltage on the DC link capacitor 2 can be detected, for example via a second voltage detector 5, which is arranged between the two terminals of the DC link capacitor 2. Similarly to the first voltage detector 4, this can be a voltage detector which provides an analog or digital output signal that corresponds to the detected voltage. After the circuit breaker 3 has been closed, a voltage of the same size as the open-circuit voltage of the electric energy store 20 will be obtained on the DC link capacitor 2, even if the DC link capacitor 2 has previously been charged to a lower or higher voltage. In this way, a reliable closure of the circuit breaker 3 can be detected.

As already described above, after a suitable enable voltage has been calculated by the control device 6, the DC link capacitor 2 can be charged up to the calculated enable voltage by the charging circuit 1. For this purpose, for example, the control device 6 can evaluate an output signal provided by the second voltage detector 5 in order to determine the voltage currently applied to the DC link capacitor 2. Depending on the calculated enable voltage and the voltage detected on the DC link capacitor 2, the control device 6 can then activate the charging circuit 1. During charging of the DC link capacitor 2 to the calculated enable voltage, only a very small quantity of energy needs to be supplied by the charging circuit 1. Therefore, during this charging process the power supplied for the DC link capacitor 2 by the charging circuit 1 can be limited. For example, the power can be limited to a few watts or if appropriate, to a power of less than one watt during the charging of the DC link capacitor 2. In particular, the power during charging of the DC link capacitor 2 can be limited to a very small fraction compared to the power during the charging of the electric energy store 20.

After it has been detected, for example by the control device 6, that the DC link capacitor 2 has been charged to the calculated enable voltage, the circuit breaker 3 can be closed. This can be done by appropriately activating the circuit breaker 3 when the DC link capacitor 2 has been charged up to the enable voltage. Thereupon, the charging of the electric energy store 20 can be enabled by the charging circuit 1. If necessary, by comparison of the detected open-circuit voltage of the electric energy store 20 with the detected voltage on the DC link capacitor 2, it can be checked in advance whether the circuit breaker 3 is correctly closed, as has already been described above. If even after closing the circuit breaker 3 a voltage difference is found between the open-circuit voltage and the voltage on the DC link capacitor 2, charging of the electric energy store 20 can be prevented and, if necessary, an error message may be output.

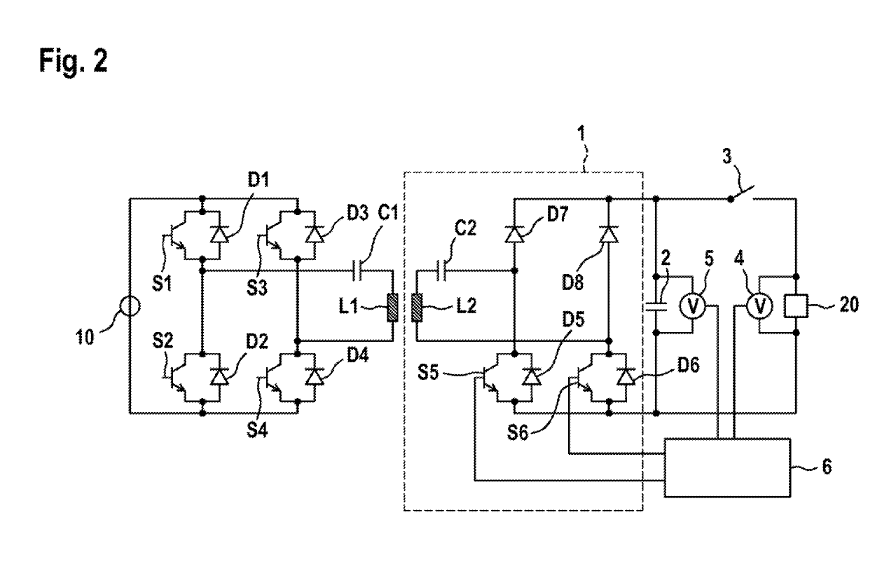

FIG. 2 shows a schematic representation of a block circuit diagram, such as forms the basis of one embodiment of a device for charging an electric energy store 20. The charging circuit 1 is fed from a DC voltage source 10. This AC voltage is first transformed into a high-frequency alternating voltage using a rectifier formed of the four switching elements S1 to S4 with the free-wheeling diodes D1 to D4 arranged parallel thereto. For example, this alternating voltage can be an alternating voltage in the range between 10 and 150 kHz. This alternating voltage feeds a resonant circuit consisting of the capacitor C1 and the coil L1. The coil L1 can be, in particular, the primary coil of an inductive energy transmission system. The alternating magnetic field generated by the coil L1 couples into an additional coil L2. For example, the other coil L2 can be the secondary coil of an inductive energy transmission system. The additional coil L2 forms a resonant circuit together with the capacitor C2. The alternating voltage applied to the series circuit consisting of capacitor C2 and additional coil L2 is rectified by means of a rectifier formed by the diodes D5 to D8. The voltage thus rectified can be provided at the output of the charging circuit 1. Parallel to each of the lower diodes D5 and D6 a switching element S5, S6 is arranged, for example a semiconductor switching element. By opening or closing these switching elements S5 and S6 a controlled charging of the DC link capacitor 2 is possible. To this end, the two switching elements S5 and S6 can be, for example, periodically opened and closed until the desired enable voltage on the DC link capacitor 2 is reached.

The previously described device for charging an electric energy store 20 is very well suited, for example, for charging an electric energy store in a vehicle, such as an electric car or a hybrid vehicle. In this way, for example the traction battery of such a vehicle can be recharged. The transfer of energy between electric energy source 10 and the electric energy store 20 in the form of the traction battery can be performed, for example, by means of an inductive charging system, wherein the primary coil is arranged outside of the vehicle and the secondary coil in the vehicle, for example in the vehicle floor. However, conductive charging systems based on the device according to the invention are also possible for charging an electric energy store 20. In particular, to provide galvanic separation between the electric energy source 10 and energy store 20, a transformer or similar device can also be provided. In addition, the device according to the invention for charging an electric energy store can also be considered suitable for use in any other systems for charging up an electric energy store. Thus, for example at the junction between the charging circuit 1 and the DC link capacitor 2 on the one side and the electric energy store 20 with the circuit breaker 3 on the other side, a plug connection can be provided. If no charging of the electric energy store 20 is taking place, for safety reasons no electrical voltage should be applied to this plug connection. Only after the plug connection between charging circuit 1 and DC link capacitor 2 and the electric energy store 20 has been made correctly with the circuit breaker 3 (and any contact with energized parts is reliably excluded), can the DC link capacitor 2 then be charged up and the circuit breaker 3 closed.

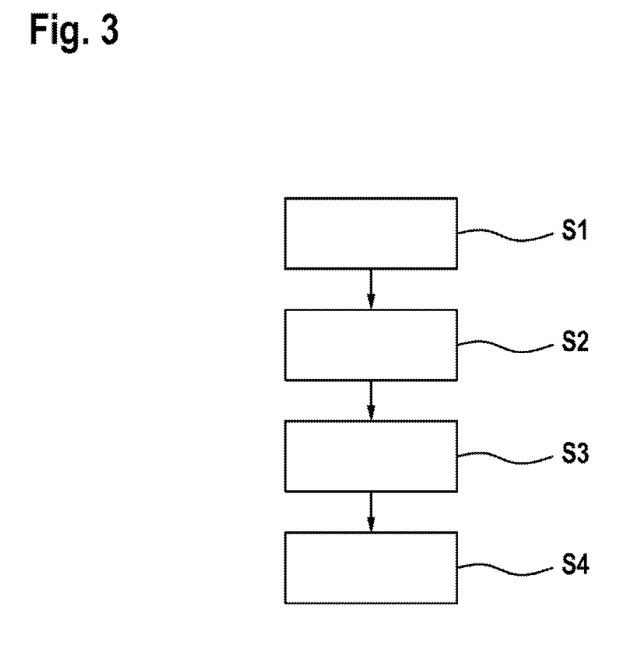

FIG. 3 shows a schematic representation of a flow diagram, such as forms the basis of a method for initializing a charging process for an electric energy store 20. In step S1 an open-circuit voltage of the electric energy store 20 is first detected. Based on this detected open-circuit voltage of the electric energy store 20, an enable voltage is calculated in step S2. Then in step S3, a DC link capacitor 2 can be charged up to the calculated enable voltage. During this process the DC link capacitor 2 is connected to the electric energy store 20 via an open circuit breaker 3. The DC link capacitor 2 is charged by means of a charging circuit 1 for the electric energy store 20. Finally, in step S4 the circuit breaker 3 between the DC link capacitor 2 and electric energy store 20 can be closed, if the value of the electrical voltage on the DC link capacitor corresponds to the enable voltage 2.

The enable voltage calculated in step S2 can be a voltage which differs from the detected open-circuit voltage of the electric energy store 20 by a predefined value or a predefined value range. In particular, the calculated enable voltage can deviate by a few volts, for example 2-5 volts, or 1-2% of the open-circuit voltage of the electric energy store 20. The calculated enable voltage can be less than or greater than the open-circuit voltage of the electric energy store 20.

During the charging of the DC link capacitor 2 in step S3 the electrical power provided by the charging circuit 1 can be limited to a predefined maximum value. For example, the electrical power provided by the charging circuit 1 during the charging of the DC link capacitor 2 can be limited to a few watts or to a power of less than one watt.

In summary, the present invention relates to an efficient charging of a DC link capacitor of a charging circuit for an electric energy store. For this purpose, the DC link capacitor of the charging circuit is firstly charged by means of the charging circuit up to a voltage in the range of an open-circuit voltage of the electric energy store to be charged. Only after the DC link capacitor has been charged to the specified voltage is the DC link capacitor electrically connected to the electric energy store to be charged.

1. A device for charging an electric energy store (20), having:
a charging circuit (1), electrically coupled at an input terminal to an electric energy source (10), and configured to provide a DC voltage or a DC current at an output terminal;
a DC link capacitor (2), electrically connected to the output terminal of the charging circuit (1);
a circuit breaker (3), positioned in an electrical path between the DC link capacitor (2) and the electric energy store (20), and configured to open or close an electrical connection between the DC link capacitor (2) and the electric energy store (20);
a first voltage detector (4), configured to detect an open-circuit voltage of the electric energy store (20);
a second voltage detector (5), configured to detect a DC link voltage between two terminals of the DC link capacitor (2); and
a control device (6), configured to calculate an enable voltage using the detected open-circuit voltage, to provide a control signal on the charging circuit (1) to charge up the DC link capacitor (2) and to activate the circuit breaker (3) when the DC link circuit voltage corresponds to the calculated enable voltage.

2. The device as claimed in claim 1,
wherein the control device (6) is configured to enable a charging process for charging the electric energy store (20) by the charging circuit (1) after the circuit breaker (3) has been closed.

3. The device as claimed in claim 1, wherein the control device (6) is configured to enable the charging of the electric energy store (20) only if a difference between the detected open-circuit voltage of the electric energy store (20) and the detected DC link voltage falls below a predefined threshold after the circuit breaker (3) has been closed.

4. The device as claimed in claim 2, wherein the control device (6) is configured to provide an enable signal, when the charging process for charging the electric energy store (20) has been enabled.

5. The device as claimed in claim 1, wherein the circuit breaker (3) comprises a multi-phase switch.

6. The device as claimed in claim 1, wherein the charging circuit (1) comprises a secondary coil of an inductive energy transmission system and a rectifier circuit.

7. The device as claimed in claim 6, wherein the rectifier circuit comprises a plurality of semiconductor switches, and the control device (6) is configured to actively control the semiconductor switches of the rectifier circuit for charging up the DC link capacitor.

8. A method for initializing a charging process of an electric energy store (20), the method comprising:
detecting (S1) an open-circuit voltage of the electric energy store (20);
calculating (S2) an enable voltage using the detected open-circuit voltage of the electric energy store (20);
charging (S3) a DC link capacitor (2) which is coupled with the electric energy store (20) via an open circuit breaker (3), by a charging circuit (1) for the electric energy store (20); and
closing (S4) the circuit breaker (3) when the value of the electrical voltage on the DC link capacitor (2) corresponds to the calculated enable voltage.

9. The method as claimed in claim 8,
wherein the step (S2) for calculating the enable voltage calculates an enable voltage which differs from the detected open-circuit voltage of the electric energy store (20) by a predefined value or a predefined range of values.

10. The method as claimed in claim 8,
wherein in step (S3) to charge up the DC link capacitor (2), the electric power provided by the charging circuit (1) is limited to a predefined maximum value.

11. The method as claimed in claim 8,
wherein the step (S3) to charge up the DC link capacitor (2) comprises an active control of semiconductor switches in a rectifier circuit of the charging circuit (1).

12. The device as claimed in claim 1, wherein the charging circuit (1) comprises a resonance transformer and a rectifier circuit.

13. The device as claimed in claim 6, wherein the rectifier circuit comprises a plurality of semiconductor switches, and the control device (6) is configured to actively control the semiconductor switches of the rectifier circuit for charging up the DC link capacitor.
